(19) United States
(12) Patent Application Publication
(10) Pub. No.: US 2012/0226579 A1
(43) Pub. Date: Sep. 6, 2012

(54) FRAUD DETECTION BASED ON SOCIAL DATA

(76) Inventors: Vida HA, San Francisco, CA (US); Nicolas GRENIE, Menlo Park, CA (US)

(21) Appl. No.: 13/436,871

(22) Filed: Mar. 31, 2012

Related U.S. Application Data
(63) Continuation-in-part of application No. 13/293,098, filed on Nov. 9, 2011.
(60) Provisional application No. 61/534,333, filed on Sep. 13, 2011.
(60) Provisional application No. 61/448,062, filed on Mar. 1, 2011.

(51) Int. Cl. G06Q 30/06

(52) U.S. Cl. 705/26.35

(57) ABSTRACT

A system or method that assesses a transaction request from a client to identify characteristics that are likely to indicate fraudulent behavior, based on data associated with the request and the client, including client data that is obtained from a social network, such as Facebook. The assessed characteristics may include the client's social profile, including number and status of friends, likes, and virtual account status, as well as parameters associated with the connection used for the transaction, such as IP and email addresses, country of origin, and language. A database is maintained that includes records associated with IP and e-mail addresses, users' characteristics and past redemptions, and the like. Specific criteria, limits, and responses may be defined for each particular class of transaction.

This application is a Continuation-In-Part of U.S. patent application Ser. No. 13/293,098, filed 9 Nov. 2011, and claims the benefit of U.S. Provisional Patent Application 61/534,333, filed 13 Sep. 2011.

### BACKGROUND AND SUMMARY OF THE INVENTION

This invention relates to the field of online marketing and sales, and in particular to a system and method for preventing potential fraud in online, non-cash, transactions.

In the parent application (U.S. Ser. No. 13/293,098) to this application, which is incorporated by reference herein, an incentive system is presented that rewards “virtual goods” to users that perform a desired action, such as purchasing “actual goods” from a vendor.

As the terms are used herein, the term “actual goods” refers to a product or service that relates to the “real world”, or the “physical environment”; typically such actual goods are purchased using conventional currency (dollars, euros, etc.). Conversely, “virtual goods” refers to a product or service that relate to “virtual worlds”, or “virtual environment”, such as a gaming environment accessible via the Internet. These virtual goods may be purchased using actual currency or credits, or virtual currency or credits. For ease of reference, the terms ‘virtual’ and ‘actual’ are used herein to distinguish between acts or items within the virtual environment and the actual environment.

The inventors have recognized that social networking and, in particular, social gaming has become one of the largest growing, if not the largest growing field of endeavors in the past few years. It is estimated that over 290 million people monthly engage in social gaming today, with revenues amounting to over a billion dollars, and that these revenues will increase to over five billion dollars by 2015.

A substantial amount of the current and projected revenue is revenue generated by in-game transactions, wherein a user may purchase a “virtual” item that facilitates advancement in the game. For example, to advance to a next level in a game may consume hours of the user's time; alternatively, the user may purchase a virtual ‘credit’, and use this virtual credit to advance to the next level immediately. In like manner, a user may purchase a virtual tool or virtual weapon for use by the user's avatar to achieve particular tasks and goals, or a user may purchase a virtual animal or virtual seeds to facilitate growth or expansion of a virtual farm.

The inventors have also recognized that although there are millions of people engaged in social gaming, very few of these ‘gamers’ are willing to actually purchase the aforementioned virtual items for use in the games. A current estimate is that only about two to three percent of the current gamers are willing to purchase such virtual items.

The inventors believe that most gamers view virtual goods as desirable, but are reluctant to enact an actual cash transaction to purchase these virtual goods. This reluctance may be based on any number of factors, such as reluctance to disclose a credit card number within a social gaming environment, a reluctance to go through the bother of a transaction, a reluctance to pay actual cash for ‘make believe’ goods, and so on.

The parent application combines the need for novel incentive programs with the expected growth and increased involvement in social gaming, by providing a simple process for obtaining virtual goods without purchasing them directly. In the example application, virtual goods are offered as an incentive to acquire new customers or reacquire former customers. Using a simple click-through process, a customer may receive a given number of virtual credits, or a particular virtual item, upon satisfying a given requirement, such as a purchase above a given amount, a subscription to a mailing list, submission of a preference profile, and so on. For ease of reference, the term ‘virtual goods’ is used hereinafter to refer to the virtual item being offered, regardless of whether the nature of the virtual item (e.g. virtual cash, virtual animal, virtual tool, etc.), and the term ‘act’ or ‘action’ is used hereinafter to refer to the criterion used to determine whether to transfer the virtual goods to the customer, regardless of the nature of the act.

Initial tests have indicated that a substantial number of customers prefer receiving virtual goods in lieu of a cash rebate or other cash-based discount, even when the actual cost associated with the virtual goods is the same as, or lower than the amount of the cash-based discount. Because the entire transaction is accomplished on-line, with no actual cash being transferred, the logistics associated with launching and executing the campaign are low enough to facilitate hi-volume, low-cost incentive programs, such as offering virtual goods if a user joins an mailing list. In a preferred embodiment, a third-party campaign manager facilitates the execution and management of the incentive campaign.

However, even though only virtual goods are provided as an incentive, rather than actual goods, these virtual goods have a ‘market value’ in terms of actual currencies or other actual resources. That is, for example, if a vendor credits the purchaser with N virtual credits in a particular virtual environment, the vendor must correspondingly pay the provider of the virtual environment for these N virtual credits, at a rate negotiated between the vendor and the provider of the virtual environment. To the recipient of the N virtual credits, the credits are worth either the amount (e.g. in actual currency) that the recipient would have had to pay for these N virtual credits, or, if the virtual credits are negotiable, the amount that the recipient would receive in exchange for these virtual credits.

Because virtual goods have actual value, a system that issues such virtual goods will likely become a target for illicit acquisition of these virtual goods. However, because in the context of incentive programs and the like, the acquisition of virtual goods will be in return for performing a particular act, rather than purchasing the virtual goods directly, the safeguards that are conventionally available to prevent fraud during actual purchases (such as immediate verification of credit cards based on the CID) are not available to the provider of the virtual goods.

It would be advantageous to identify potentially fraudulent activity during the issuance of virtual goods. It would also be advantageous to identify such potentially fraudulent activity using information that is commonly available. It would also be advantageous if the assessment associated with the identification is transparent to the person being assessed.

These advantages, and others, may be achieved by a system or method that assesses each redemption attempt to identify characteristics that are likely to indicate fraudulent behavior. The assessed characteristics may include parameters associated with the connection used for the redemption, such as IP and email addresses, country of origin, and language, the redeemer's social profile, including number and status of friends, likes, and virtual account status. A database is maintained that includes records associated with IP and e-mail addresses, users' characteristics and past redemptions, and the like. Specific criterion, limits, and responses may be defined for each particular incentive campaign.

### BRIEF DESCRIPTION OF THE DRAWINGS

The invention is explained in further detail, and by way of example, with reference to the accompanying drawings wherein:

FIG. 1 illustrates an example flow diagram for a virtual goods incentive system.

FIGS. 2A-2D illustrate example screen shots provided to the customer by the virtual goods incentive system.

FIG. 3 illustrates an example flow diagram for a virtual goods incentive system using a third-party campaign manager.

FIG. 4 illustrates an example flow diagram for assessing a client's social data, and other data associated with a transaction request.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

For the purposes of this disclosure, the terms “virtual” and “actual” are used herein to distinguish elements that exist only within an artificial, or software, environment from those that exist in reality. A virtual cow, for example, is a simulacrum in a virtual environment that performs in the virtual environment in a manner similar to an actual cow on an actual farm. Virtual cash, in like manner, is used in a virtual environment in a manner similar to actual cash in the physical world.

The parent invention is premised on the observation that social gamers perceive virtual goods, such as Facebook credits, Cityville cash, Farmville animals, and the like, as being valuable, and that if a simple and straightforward interface were provided to easily obtain such virtual goods, more gamers would begin using virtual goods to enhance their gaming enjoyment.

The parent invention is also premised on the observation that offering virtual goods, instead of actual goods, as an incentive by a retailer will distinguish this retailer from other retailers, and if the overall value associated with obtaining the virtual goods is perceived by the customer as being more desirable than actual goods having a higher cost to the retailer, the cost of providing the virtual goods incentive will be less.

A further advantage of coupling an incentive program to social gaming is that the gaming environment typically includes a profile of each gamer, and this profile may be used to facilitate subsequent contacts with the gamer, encouraging further interactions with the retailer.

In accordance with an aspect of this invention, the user's profile, and other social data, is used to provide an assessment of risk associated with issuing the virtual goods to the user, as detailed further below, in the context of a virtual goods incentive system. One of skill in the art will recognize that the principles and techniques presented herein will be applicable to other commercial transaction requests, including transactions involving actual goods, by users having an accessible social profile.

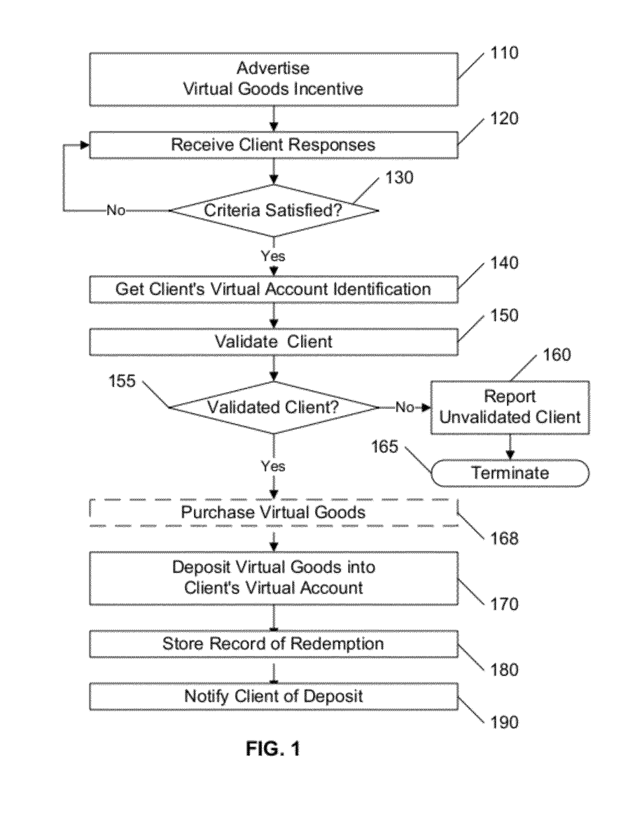

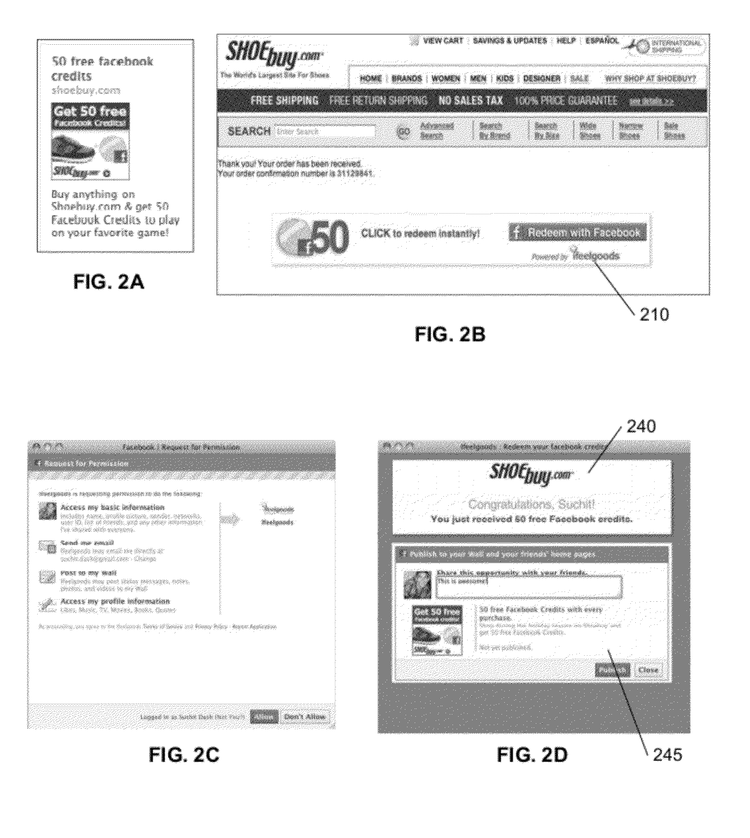

FIG. 1 illustrates an example flow diagram for a virtual goods incentive system, and FIGS. 2A-2D illustrate example screen shots of an example system. For the purposes of this disclosure, the term ‘client’ is used hereinafter to identify the ‘target’ of the incentive program; that is, the person from whom a desired action is solicited, such as a purchase, a subscription, a response, and so on. For ease of understanding, this invention is presented in the context of offering virtual goods as an incentive for purchasing actual goods, although one of skill in the art will recognize that virtual goods may be offered as an incentive for other actions on the part of the client.

At 110, the offer for the actual goods and the incentive of obtaining virtual goods is advertised to the client. An example advertisement for receiving fifty Facebook credits with any purchase is illustrated in FIG. 2A. In other campaigns, the advertisement could be for receiving five Facebook credits for subscribing to a mailing list, or for ‘liking’ a particular vendor or product.

At 120, the client's responses are received and processed. Such responses may include typical web-page interactions, click-throughs, searches, and so on. At some point, the client may perform the desired purchase of the actual goods, and, at 130, the system will proceed to satisfy the advertised offer. An example action-completed message is illustrated in FIG. 2B, advising the client that the desired action was performed, and inviting 210 the client to proceed to redeem the advertised offer for virtual goods, in this case, the aforementioned fifty Facebook credits.

To initiate the redemption process, the system queries the user to obtain the information necessary to effect the transfer of the virtual goods to the user's virtual account, at 140. The particular procedure for accessing the client's virtual account and provide a deposit will be dependent upon the particular virtual environment associated with the virtual account. Most virtual environments allow users to ‘gift’ credits from one user to another, and in a preferred embodiment, the provider of the incentive establishes a relationship with the provider of the environment to facilitate such transfers.

In the example of a deposit to a Facebook account, FIG. 2C illustrates an example Facebook ‘Request for Permission’ page. In a preferred embodiment of this invention, in addition to requesting permission to post to the user's Facebook wall in order to make the actual deposit, the system also requests permission to obtain the user's e-mail address and to access the user's profile information. The e-mail address is nominally requested for sending a confirmation e-mail regarding the deposit of the virtual goods, but also serves to allow the retailer to send targeted e-mails to the client with other offers and incentives and to validate the email inputted to ensure quality leads & information about the customer. The client's profile information may be stored and subsequently used to determine the client's preferences and demographics, to facilitate selective targeting and personalization.

For example, the client's profile information may indicate that the client is a frequent Farmville gamer, and a targeted incentive could include virtual farm animals; in like manner, if the client is not a Farmville gamer, Farmville-based virtual objects would not be offered, or an offer to join Farmville might be offered. The profile information may also be used to identify actual objects that the client may have an interest in, based on the client's gender, age, expressed interests, and so on. For example, if the client indicates that he/she is an avid runner, offers for high-performance sneakers may be appropriate.

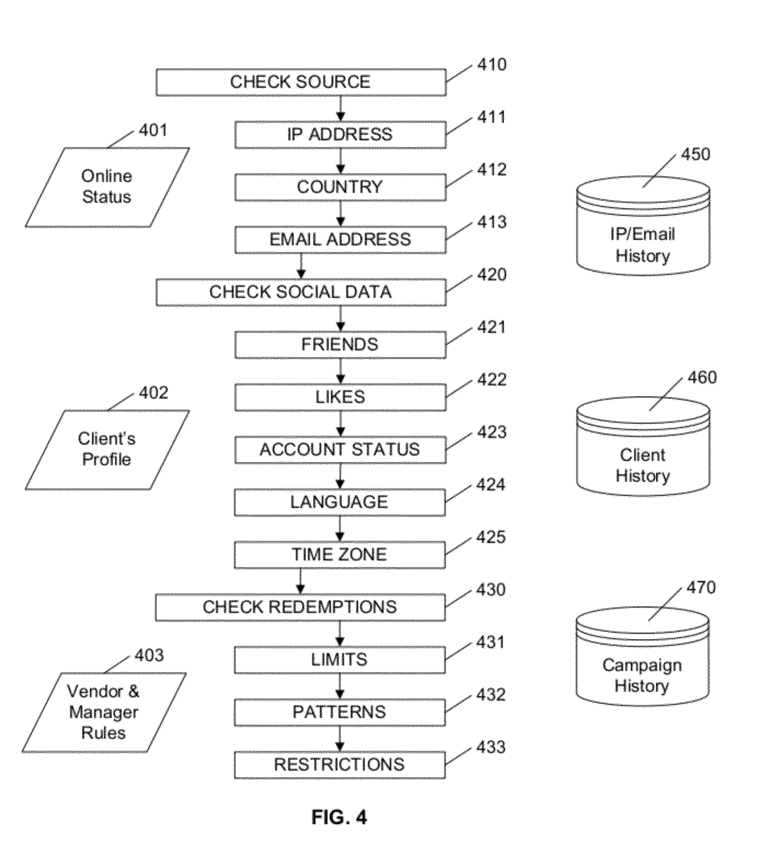

In accordance with an aspect of this invention, the client's profile information, and other information related to this particular client, is assessed at 150 to validate the client. This validation may be absolute, such as restricting redemptions to clients in a particular country, or relative, based on heuristic indicators of a potentially fraudulent redemption attempt, as detailed further below with respect to FIG. 4. Note that, for convenience, the term ‘fraud’ is used herein to identify any unqualified redemption attempts, regardless of the cause of the non-qualification.

In the current example of a redemption in return for an actual purchase, it may be difficult for a client to fraudulently repeat the transaction required to initiate the redemption process; in other incentive programs, however, such as incentives for joining a mailing list, it may be relatively easy for a client to repeat the qualifying transaction, using, for example, bogus email addresses or aliases. And, although safeguards are taken to assure that the user has actually performed the qualifying transaction, a flaw in such safeguards could enable a client to collect multiple redemptions without actually performing the corresponding multiple qualifying transactions.

If, at 155, the client is not validated, the redemption is blocked. A report of the rejection, including the basis for rejection, is made, at 160, and a record of the rejection is stored for future use. Depending upon the particular campaign and/or the particular basis for rejection, the provider of the incentive may take additional action upon receipt of this reported rejection. For example, if the rejection is based on the aforementioned heuristic indicators of potentially fraudulent redemption attempts, the client may be notified that a problem exists and instructed to call for further information. The redemption may be reinstated based on whether the client follows up with the call, and/or whether the conversation with the client alleviates the suspicion of a fraudulent redemption.

If, at 155, the client is validated, the redemption process continues. Depending upon the particular arrangement between the provider of the incentive and the virtual environment provider, the incentive provider may need to purchase the virtual goods for each redemption, at 168. In most cases, the incentive provider will have established a credit account with the environment provider.

At 170, the virtual goods are deposited into the client's virtual account, and at 180, the campaign provider's database is updated to store a record of the redemption, including aspects of the client's profile.

At 190, the client is notified of the virtual goods deposit; FIG. 2D illustrates such an example notice 240. Also illustrated at 245 in FIG. 2D, the client is provided the opportunity to publish an opinion of the transaction, including the original advertisement of FIG. 2A. In a preferred embodiment, this publication may also be sent to the client's friends on Facebook. Optionally, the user's agreement to publish the opinion may also result in the deposit of additional virtual objects into the client's virtual account.

Although the above material describes the general concepts of this invention, the inventors have also recognized that providing this interaction with virtual environments and virtual accounts is not necessarily an activity that fits within the interests or skill-sets of a conventional actual goods retailer. In like manner, increasing a client's balance in a virtual account is not necessarily an activity that the provider of the virtual account would want to be performed by any and all retailers. The risk of fraud and the overhead associated with maintaining actual accounts for receiving the deposits of actual funds corresponding to the purchase of virtual goods that are deposited to the various client virtual accounts, as well as the potential need to mitigate disputes between the client and the retailer, may be a significant disincentive for the provider of the client virtual accounts. Conventionally, although the transfer of credits or goods between a gamer and the provider of the game is controlled by the provider of the game, the purchase of virtual credits using actual funds is generally solely controlled by the provider of the virtual account.

In a preferred embodiment of this invention, a third-party campaign manager provides the interface among the virtual account provider, the retailer, and the client. Preferably, the third party campaign manager warrants the transfer of actual funds to the virtual account provider and the transfer of virtual goods to the client on behalf of the retailer. In this manner, the retailer need not become involved in the logistics and details associated with implementing the virtual goods transfers, and the provider of the virtual account is able to grant explicit authorization to a limited number of parties that are authorized to increase the balance in any client's virtual account.

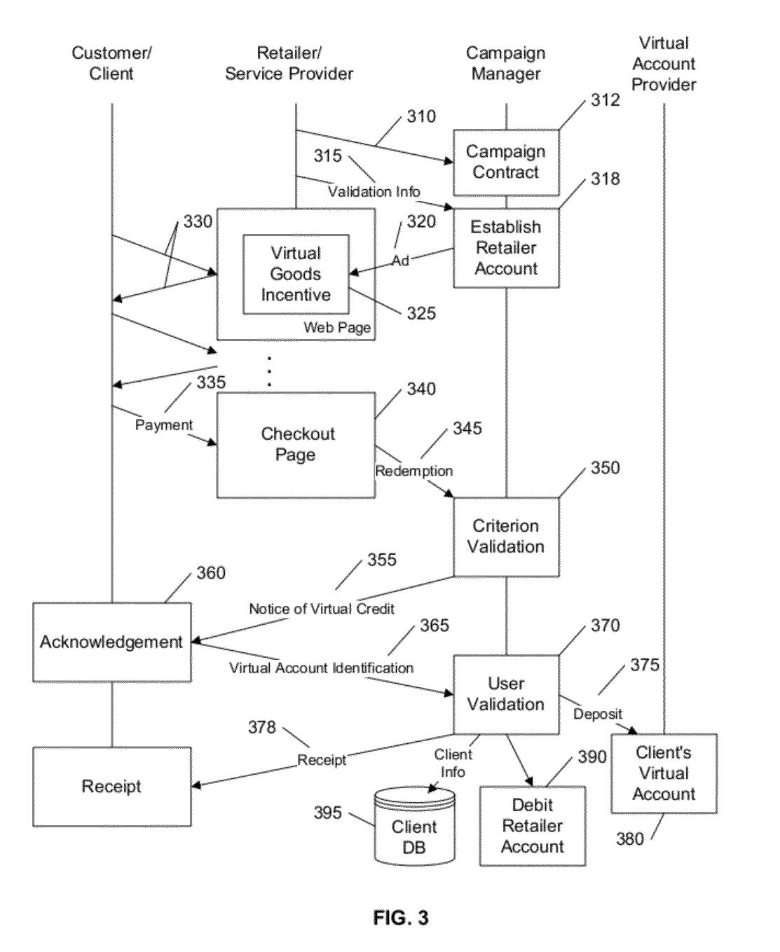

FIG. 3 illustrates an example flow diagram for a virtual goods incentive system using a third-party campaign manager.

A retailer that desires to add a virtual goods incentive program to an advertising program for actual goods contacts 310 the campaign manager and enters into a contract 312 with the campaign manager. The contract may take any number of forms, including a fixed price contract, but in general, a commission-based contract is particularly well suited for marketing campaigns. Generally, the campaign manager will establish an account 318 for the retailer, with a fixed ceiling amount that sets an upper limit to the cost of providing the virtual goods incentive. Associated with this account is confidential information 315 associated with the retailer that serves to validate transactions related to the retailer's account, as detailed further below. Depending upon the particular contract, the retailer may be required to provide a down payment of actual funds to support the campaign, and/or to replenish the actual funds as the balance in the account is drawn down by the purchase of the virtual goods that are transferred to the clients.

In an example embodiment of this invention, the campaign manager provides 320 the advertisement 325 for the virtual goods incentive, such as the advertisement illustrated in FIG. 2A. Preferably, instantiating the advertisement 325 establishes a link to the campaign manager, and the incentive is displayed only if the actual costs expended for the virtual goods incentive is below the aforementioned ceiling amount established for the retailer's account.

Thereafter, the client interacts 330 with the retailer's web site, and, in this example, eventually executes a purchase for an actual object and remits payment 335 while interacting with the checkout page 340. Upon completion of the purchase, the retailer notifies 345 the campaign manager that the purchase has been completed, and instructs the campaign manager to redeem the offer of virtual goods for the client.

To avoid fraudulent notifications of a qualifying transaction, the vendor preferably communicates a unique identifier of the particular client transaction to the campaign manager, and a secure token that validates that this redemption is authorized by the identified retailer. Any number of symmetric or asymmetric encryption techniques may be used to create the token. In an example embodiment, the vendor encodes the unique identifier using a secret key that is unique to the vendor, and the campaign manager has a corresponding key for decoding the unique transaction identifier.

Upon receipt of the parameters in the redemption message 345 from the retailer, the campaign manager validates that the redemption message is a proper and authorized redemption request, at 350, by decoding the unique identifier using a key that is specific to the vendor.

If the determined result matches the unique identifier, the campaign manager verifies that this redemption request is not a duplicate request by checking the retailer's account for this unique identifier. After validating that the redemption request is authorized by the retailer, and not a repeat of a previously granted redemption request, the campaign manager notifies 355 the client that the redemption process for the offered virtual goods is underway. The client acknowledges the transaction by providing the necessary information 365 for accessing the client's virtual account 380. In the example of Facebook virtual goods, the client allows the campaign manager to access the client's Facebook information and to post to the client's wall, as detailed above with respect to FIG. 2C. Other virtual environments may provide different protocols and APIs (Application Program Interfaces) for accessing a client's virtual account to make deposits.

As noted above, in addition to gaining access to the client's virtual account to deposit the virtual goods, the campaign manager also accesses the information that the client has allowed the campaign manager to access, such as the client's basic information (name, gender, age, etc.) and profile information (likes and dislikes, favorite activities, etc.). In a preferred embodiment of this invention, the campaign manager maintains a client database 395 for storing this information for each client.

Prior to executing a deposit to the client's account, the particular client is validated, based on the information contained in the client's virtual account, and other information, as illustrated in FIG. 4.

The validation process includes an assessment of three aspects of the transaction to determine whether there is reason to believe that the user is not a valid recipient of the redemption. As noted above, the term ‘fraud’ is used for convenience, and includes both intentional and unintentional attempts to redeem an invalid redemption. Alternatively, one may embody this validation process using an inverse of an indication of ‘fraud’, such as an indication of ‘trustworthiness’, ‘credibility’, or simply ‘validity’.

The first aspect 410 that is assessed is the source of the request for the redemption, based, for example, on the parameters 401 associated with the particular online transaction. For the purposes of this disclosure, the client's response (365 of FIG. 3) to the requests to provide information (355) to effect a redemption is considered a ‘request’ for the redemption from the client, even though the initial request (345) may have been sent by the vendor, on behalf of the client.

At 411, the IP address associated with the current transaction is assessed to identify any indication that this request may be fraudulent. In a preferred embodiment, the campaign manager maintains a database 450 of actions associated with each IP address and e-mail address. The information in the database may include specific IP addresses as well as ranges of IP addresses. If the database indicates that this IP address has been associated with prior fraud attempts, the redemption will be blocked. In a preferred embodiment, clients may be provided an opportunity to clear the record, if it can be shown that the fraud determination is incorrect and/or outdated.

At 412, the country of origin of the request is determined, typically based on the IP address, using, for example the GeoIP service provided by MaxMind. The check for a valid country may be inclusive or exclusive. That is, the particular campaign may be restricted to a particular set of countries, or all campaigns may be prohibited in another set of countries. If the source country is not a valid country for the campaign, the redemption will be blocked.

At 413, the e-mail address is compared to the data in the database 450 to determine if this e-mail address is associated with prior fraudulent attempts; if so, the redemption will be blocked. Preferably, the system is configured to recognize e-mail aliases, such as “name+###@gmail.com” being an alias for “name@gmail.com”, where “#” is any numeric character. Such aliases will be resolved to a single email address, and the actions on any of the addresses will be associated with the single email address, and any fraud determinations will be applicable to all aliases. Note that the use of aliases per se is not considered to be indicative of fraudulent activity, but by consolidating all of the actions at each alias, the use of aliases to circumvent limits associated with a campaign will be detected as fraudulent activity, as detailed further below.

The second aspect 420 that is assessed is the user's profile at the virtual environment, which is generally ‘social data’ associated with the client. In this example, the information in a Facebook profile is provided as a paradigm for demonstrating how such social data may be used to assess the validity of the client, although one of skill in the art will recognize that information in other virtual environments may similarly be used.

Because social characteristics are assessed based on subjective and/or heuristic factors that are considered to be related to the likelihood of a fraudulent redemption, rather than absolute criteria such as prohibited countries, a composite of the individual assessments is preferably used to assess whether the redemption should be blocked. In a preferred embodiment, each individual assessment provides a ‘fraud score’, and the composite will be based on these scores. The different assessments may be considered to have different reliabilities, and the composite assessment may take such reliabilities into account, using, for example, a weighting factor for each assessment. Thresholding may also be applied within the individual assessments as well as in the final determination of whether the composite indicates sufficient cause for concern that the redemption is fraudulent and should be blocked.

One of skill in the art will recognize that a variety of techniques are commonly available for reaching a decision based on a plurality of subjective assessments, such as making the decision based on whether a weighted average of the scores is above a given threshold, making the decision based on a “fuzzy logic” approach, making the decision using an “inference engine” that is trained by a learning system, and so on. Additionally, the decision may be dependent upon the particular campaign. For example, the decision may be dependent upon the value of the redemption, or based on a risk level set by the vendor.

For ease of presentation and understanding, the following descriptions of the assessment of each item of the example social data will be presented in terms of its effect on a ‘score’, wherein a higher score indicates a higher likelihood of potential fraud. The fraud scores are initially set to zero, then increased, or in some instances, decreased, based on the assessment of the individual social factors. Optionally, the system may be configured to initialize the score to a value that is based on the client's history 460, giving a consistently validated client a negative initial fraud score, and a client that has previously been denied validation a positive initial fraud score. This initial positive fraud score for prior denials may also be dependent upon the particular reasons for the denial.

At 421, the client's “Friends” is assessed for indications of potential fraud. One method of avoiding limits in a campaign, such as “one redemption per client”, is to establish a number of different Facebook accounts, using different names, addresses, and so on. In an embodiment of this invention, the number of Friends is used as a potential fraud indicator; a client is not likely to establish Friends within each of the different Facebook accounts that are set up merely to accumulate credits. Accordingly, the fraud score is increased inversely to the number of Friends. A threshold number of Friends may be used to leave the fraud score unaffected, or, in some embodiments, to decrease the fraud score. For example, fewer than ten Friends may increase the fraud score, and more than fifty Friends may decrease the fraud score; numbers of Friends between ten and fifty would have no effect on the fraud score.

The Friends data is also assessed to determine characteristics associated with each of the client's Friends, using the database 460 of actions, if any, associated with each Friend. If the client's Friend is characterized as being associated with fraudulent activity, the fraud score is increased. Optionally, if the client's Friend is characterized as a reliable and credible client, the fraud score may be decreased.

Similarly, the client's “Likes” are assessed, at 422. As with the “Friends” assessment, an account with few expressed Likes increases the fraud score, and, optionally, an account with many expressed Likes may decrease the fraud score.

One of skill in the art will recognize that other social factors associated with the client's Facebook account may also be assessed to determine whether the fraud score should be increased or decreased. For example, the number of pictures posted, the number and type of postings, and so on.

At 423, the characteristics of the client's Facebook account are assessed. For example, the age of the account, the age and recency of postings, and so on may affect the fraud score; a well established and active account, for example, may serve to decrease the fraud score, while a recently established account or an account with no recent postings may serve to increase the fraud score.

Additionally, each Facebook account includes a ‘verified’ status, the verification being based on client provided information, such as telephone number, credit card information, and the like. If a client's account is not verified, Facebook requires the client to perform verification tasks, such as entering the characters shown in a “captcha” box, before executing a Facebook task. Accordingly, most active Facebook clients provide their personal information, to avoid being interrupted with such verification tasks. Correspondingly, in an embodiment of this invention, if the status of the client's account is ‘not-verified’, the fraud score is increased.

At 424, the Facebook “Language” characteristic is assessed. Generally, the Language will be associated with a particular country or set of countries. It would be unusual, for example, for someone in the United States to set their Language to German, because only German-speaking people would be able to understand the client's postings. On the other hand, English or Spanish might be commonly used. Accordingly, if the client's Language is not associated with a permitted country for the particular campaign, or if the country is otherwise excluded, the fraud score is increased.

It is significant to note that in the above determination of country based on IP address, the decision whether to block the redemption is absolute, whereas a determination of country based on Language is more subjective, and thus is one of many factors that affect the scores used to determine whether to block the redemption.

At 425, the “Time Zone” parameter is assessed. Facebook accurately determines the time zone from where the client is using Facebook, even if the client is behind a ‘proxy’ that hides the client's actual IP address. In an embodiment of this invention, the Time Zone is compared with time zones associated with the country determined based on the IP address, above. If the Time Zone does not correspond to the determined (and permitted) country, the fraud score is increased. In some embodiments, a mismatch between Time Zone and country may be grounds for an absolute decision to block the redemption, regardless of the fraud score.

Additionally, although proxies are commonly used, and are not, per se, indicative of potential fraud, the proxy device is usually within the general vicinity of the client that is using the proxy device. If it is determined that the time zone associated with the IP address is different from the Time Zone of the client's current location, indicating that the client is using a distant proxy, the fraud score is increased.

The third aspect 430 that is assessed is the parameters and rules associated with the particular campaign, as well as the client's actions with regard to this campaign.

As noted above, a set of limits 431 will generally be established for each campaign. These limits may include, for examples, limits to the number or rate of redemptions per client, the number or rate of redemptions overall, and so on. For example, the campaign may limit redemptions to a particular number per client, or to a particular number per day per client, and so on. Or, if the incentive program is exceeding expectations or budget allowance, the campaign may be structured to cut off the redemptions, or to slow down the redemption process by limiting the number of redemptions per hour, per day, etc. If any of the limits are above the specified number or rate, the redemption is blocked.

At 432, patterns of behavior are assessed. If the records in the database 460 indicate that this client has had a number of unsuccessful attempts to become validated, but now appears to have prevailed, something must have changed. The system's reaction to this new status will be dependent upon what has changed. In an embodiment of this invention, the system analyzes the client's history 460 to determine the change, and reacts accordingly, based, for example, on a set of rules 403 established by the campaign manager. These rules may be ‘global’ and apply to all campaigns, or specific to each campaign or each type of campaign. For example, as with the basic decision regarding whether to block the transaction, the rules may vary depending upon the cost of the particular redemption, or based on a risk level established by the vendor.

If the change, for example, is a change of the client's Time Zone, indicating that the client's current Time Zone is consistent with the permitted country, or consistent with the time zone determined by the IP address, then the system will validate the client. If, on the other hand, the change is merely to the recency of a posting to the client's Facebook wall, the system may not validate the client, on the assumption that the client merely did the posting in an attempt to overcome the prior denials of the redemptions to that account.

In like manner, patterns of the client's behavior may be assessed to adjust the fraud score before the final validation determination is made. For example, if the system is set up to notify the client of a problem in granting the redemption and advises the client to call customer support, each subsequent redemption attempt before the call is made may result in a further decrease in the fraud score.

At 433, any remaining restrictions are applied. For example, some campaigns may be prohibited in certain states or municipalities, or subject to other local restrictions.

“Negative” restrictions may also be applied, wherein the fraud score is decreased under certain circumstances. For example, the vendor may be targeting a particular locale, gender, age group, etc., and may accept a higher level of risk for such target groups, to decrease the likelihood of erroneously denying redemption to these groups. If the client falls into one of these targeted groups, the fraud score is reduced prior to the final validation process.

One of skill in the art will recognize that other criteria may be used to increase or decrease the risk of fraud by adjusting the fraud score, with a corresponding decrease or increase in the likelihood of erroneously invalidating a client.

As noted above, the resultant fraud score, or set of individual fraud scores, is used to determine an overall assessment of the client's validity. In addition to blocking the redemption if the composite fraud score is high, if the composite fraud score is very low, the client may be identified as a credible and reliable client in the database 460, and this characterization may be used to expedite subsequent validations, in some cases bypassing particular assessments. This characterization of the client may also be used in the aforementioned assessment of a subsequent client who has “Friended” this favored client.

Upon completion of the assessment, the databases 450, 460, and 470 are updated to record the pertinent facts and determinations regarding this redemption transaction.

In a preferred embodiment of this invention, background processes are used to periodically analyze and/or consolidate the information contained in these databases 450-470. For example, the database 450 may be analyzed to determine how often any particular IP address has been used to request a redemption, and if the number or rate of redemptions is above a given threshold, a notification is provided to the campaign manager, for investigation. If a subsequent investigation reveals a problem associated with this IP address, the campaign manager may ‘blacklist’ the IP address, preventing any further redemptions by clients using this IP address.

Other analyses may be performed to ‘grade’ particular addresses or particular clients, and these grades may be used to adjust the initial fraud score for a request from that address or client accordingly.

One of skill in the art will recognize that over time, the records in these databases 450-470 will provide a robust and reliable tool for assessing commercial transactions, and may be used for validation of transactions beyond the scope of redemptions to virtual accounts.

Returning to FIG. 3, upon validation of the client, the campaign manager deposits 375 the offered virtual goods into the client's virtual account 380, notifies 378 the client of the deposit, and records 390 this deposit in the retailer's account.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry) or software portions (e.g., computer programming).

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and does not imply any particular range of number of elements; that is, a plurality of elements can be as few as two elements, and can include an immeasurable number of elements.

We claim:

1. A method comprising:
receiving, at a server system, a transaction request from a client,
obtaining, by the server system, access to social data associated with the client,
analyzing, by the server system, the social data to determine whether to validate the client, and
performing, by the server system, the transaction only if the client is validated.

2. The method of claim 1, wherein the transaction request is a request to deposit virtual goods to an account associated with the client.

3. The method of claim 1, wherein the transaction request is a request to provide actual goods to the client.

4. The method of claim 1, wherein determining whether to validate the client is also based on communications information related to a source of the transaction request.

5. The method of claim 4, wherein the communications information includes at least one of: an IP address, a country, and an e-mail address associated with the source.

6. The method of claim 1, wherein analyzing the social data is based on at least one of: identified other clients, a determined quantity of identified other clients, characteristics associated with the other clients, and a determined quantity of identified items that the client likes.

7. The method of claim 1, wherein analyzing the social data is based on at least one of: a time zone and a country associated with the client.

8. The method of claim 1, wherein the social data is obtained from a client account, and determining whether to validate the client is based on a status of the client account.

9. The method of claim 1, including storing information related to the transaction request, and wherein determining whether to validate the client is also based on stored information related to prior transaction requests.

10. The method of claim 9, wherein determining whether to validate the client is based on at least one of: a history of prior redemption requests from an IP address associated with the transaction request, a history associated with an email address of the client, a history associated with aliases of the email address of the client, a history of prior redemption requests from the client, and a determined quantity of other transaction requests from the client.

11. A non-transitory computer-readable medium that includes code that, when executed by a processor, causes the processor to:
receive a transaction request from a client,
obtain access to social data associated with the client,
analyze the social data to determine whether to validate the client, and
perform the transaction only if the client is validated.

12. The medium of claim 11, wherein the transaction request is a request to deposit virtual goods to an account associated with the client.

13. The medium of claim 11, wherein the transaction request is a request to provide actual goods to the client.

14. The medium of claim 11, wherein determining whether to validate the client is also based on communications information related to a source of the transaction request.

15. The medium of claim 14, wherein the communications information includes at least one of: an IP address, a country, and an e-mail address associated with the source.

16. The medium of claim 11, wherein analyzing the social data to determine whether to validate the client is based on at least one of: identified other clients, a determined quantity of identified other clients, characteristics associated with the other clients, and a determined quantity of identified items that the client likes.

17. The medium of claim 11, wherein analyzing the social data to determine whether to validate the client is based on at least one of: a time zone and a country associated with the client.

18. The medium of claim 11, wherein the social data is obtained from a client account, and analyzing the social data to determine whether to validate the client is based on a status of the client account.

19. The medium of claim 11, including storing information related to the transaction request, and wherein determining whether to validate the client is also based on stored information related to prior transaction requests.

20. The medium of claim 19, wherein determining whether to validate the client based on the stored information is based on at least one of: a history of prior redemption requests from an IP address associated with the transaction request, a history associated with an email address of the client, a history associated with aliases of the email address of the client, a history of prior redemption requests from the client, and a determined quantity of other transaction requests from the client.

21. A server comprising:
a memory that stores a database of information related to transaction requests of a plurality of clients,
a processor that:
receives a transaction request from a client,
obtains access to social data associated with the client,
analyzes the social data to determine whether to validate the client,
performs the transaction only if the client is validated, and
stores the information related to the transaction request of the client in the database.

22. The server of claim 21, wherein the processor also analyzes communications information related to a source of the transaction request.

23. The server of claim 22, wherein the communications information includes at least one of: an IP address, a country, and an e-mail address associated with the source.

24. The server of claim 21, wherein the processor analyzes the social data based on at least one of: a determined quantity of identified other clients, characteristics associated with the other clients, a determined quantity of identified items that the client likes, and a time zone associated with the client.

25. The server of claim 21, wherein the social data is obtained from a client account, and the processor analyzes the social data based on a status of the client account.

26. The server of claim 21, wherein the processor also analyzes the information in the database that is related to prior transaction requests to determine whether to validate the client.

27. The server of claim 26, wherein the processor analyzes the information in the database based on at least one of: a history of prior redemption requests from an IP address associated with the transaction request, a history associated with an email address of the client, a history associated with aliases of the email address of the client, a history of prior redemption requests from the client, and a determined quantity of other transaction requests from the client.

28. A method comprising:
presenting, to a client device, an advertisement from a retailer to a client for receiving virtual goods in return for purchase of actual goods,
receiving, at a server system, a response from the client based on the advertisement,
obtaining, by the server system, an identifier of a virtual account associated with the client,
verifying, at the server system, the response from the client, and if the response is verified, depositing the virtual goods to the identified virtual account,
wherein the verifying includes:
verification of the purchase, and
validation of the client based on social information associated with the virtual account.

29. The method of claim 28, wherein the validation of the client based on the social information is based on at least one of: identified other clients, a determined quantity of identified other clients, characteristics associated with the other clients, and a determined quantity of identified items that the client likes.

30. The method of claim 28, wherein the validation of the client is also based on a status of the virtual account.
